(19) United States
(12) Patent Application Publication
(10) Pub. No.: US 2013/0034721 A1
(43) Pub. Date: Feb. 7, 2013

(54) POLYMER MODIFIED MORTAR FOR ROOFING SYSTEM

(71) Applicants: Yanyan Wang, Pudong District (CN); Wulong X. Xu, Chaoyang (CN); Liang Zhang, Shanghai (CN); Loganathan Ravisanker, Shanghai (CN); Hari Parvatareddy, Pune (IN)

(72) Inventors: Yanyan Wang, Pudong District (CN); Wulong X. Xu, Chaoyang (CN); Liang Zhang, Shanghai (CN); Loganathan Ravisanker, Shanghai (CN); Hari Parvatareddy, Pune (IN)

(21) Appl. No.: 13/634,142

(22) PCT Filed: Apr. 21, 2010
(86) PCT No.: PCT/CN2010/071994

§ 371 Date: Sep. 11, 2012

(51) Int. Cl. E04D 13/16; C09J 7/02; B32B 7/10

(52) U.S. Cl. 428/317.3

(57) ABSTRACT

A roofing system comprising a thermal insulation foam layer which is applied onto a roof deck, and a mortar layer, wherein the thermal insulation foam layer is between the roof deck and the mortar layer. The mortar layer is made of a mortar composition, which could achieve the ratio of compressive strength to bending strength is less than 3 while keeping the bending strength larger than 7 MPa.

### BACKGROUND OF THE INVENTION

1. Field of the Invention

The present invention relates to a cement based polymer modified roofing system in construction industry. Particularly, the present invention relates to a latex modified waterproofing mortar for a spray polyurethane roofing system.

2. Discussion of Background Information

Thermal insulation is a widely applied technology in construction industry. Spray Polyurethane (SPU) based roofing systems are becoming popular in the construction market because of the higher thermal resistance offered by the polyurethane. Spray Polyurethane, as the name implies, is sprayed as a continuous layer on the roof. Traditional insulation sheets, such as expanded polystyrene foam board (EPS board) and extruded polystyrene foam board (XPS board) are placed side by side on the roof. If not sealed properly via waterproof membranes or by other means, such traditional structure can lead to water leakage through gaps between foam boards. On the contrary, Sprayed Polyurethane combined with a thin layer of polymer modified mortar can provide an integrated insulation and waterproofing function to the roof that is free of gaps.

In a typical SPU roofing system structure, the upper surface of the Spray Polyurethane foam is covered by a polymeric mortar layer and as a whole, they can provide waterproofing and insulation to the roof. The other function of the polymeric mortar in the system is to provide mechanical protection to the Spray Polyurethane. There are many problems in these conventional polymeric mortars. Most mortars do not result in a desirable ratio of compressive strength to bending strength while keeping acceptable bending strength. Under standard requirements, such as GB50404-2007, the ratio of compressive strength to bending strength at a bending strength of 7 megapascal (hereinafter “MPa”) is suggested to be less than 3.0. A higher ratio of compressive strength to bending strength will increase the risk of mortar cracking and detachment upon substrate (roof deck) deformation.

US005185389A teaches a typical latex modified mortar used as a dispatching composition, which comprises 66% sand, 22% cement, 2.1%-4.6% Dow 460 latex, 0.11% antifoam B and water. Such mortar composition comprises a lower content of cement. A mortar layer produced from such a composition does not meet the requirements of bending strength and could not obtain a desirable ratio of compressive strength to bending strength under GB50404-2007 for the application in a roofing system.

There is a need in the prior art to provide a mortar layer used in roofing, which could reach a ratio of compressive strength to bending strength that is less than 3.0 and at the same time keep bending strength larger than 7 MPa.

### BRIEF SUMMARY OF THE PRESENT INVENTION

The present invention provides a polymer modified cement based mortar composition that provides a layer having a ratio of compressive strength to bending strength that is lower than 3.0 and at the same time a bending strength above 9 MPa. Additional advantages include a bonding strength between the SPU layer and the mortar layer being above 0.2 MPa and a water absorption rate of the mortar layer being lower than 2%.

The present invention relates to a roofing system comprising a thermal insulation foam layer that is applied onto a roof deck and a mortar layer, wherein said thermal insulation foam layer is between said roof deck and said mortar layer and said mortar layer is made of a mortar composition comprising 28-40% cement, 40-60% aggregate, 0.05-0.2% defoamer, and 2.5-7% polymer by weight of the total weight of said composition, wherein the weight ratio of latex to cement is 0.12 or more.

In one embodiment of such mortar composition, the weight ratio of defoamer to latex is 0.01 or less.

In one embodiment, the aggregate/cement weight ratio of said mortar composition is from about 1.5 to 2.3.

In one embodiment, the Tg (glass transition temperature) of said polymer is in a range from −10 to 8 degrees Celsius (° C.).

In one embodiment, said thermal insulation foam layer is spray polyurethane foam.

In one embodiment, said composition further comprises an anti-crack additive of 0.1-0.4% by weight of the total weight of said composition,

In one embodiment, said anti-crack additive is polypropylene fiber.

In one embodiment, said composition further comprises a dispersant of 0.05-0.4% by weight of the total weight of said composition.

In one embodiment, the weight ratio of said dispersant to said polymer is 3% or less by weight of the total weight of said composition.

In one embodiment, said dispersant is anionic acrylic copolymer.

In one embodiment, said aggregate is silica sand and said cement is Portland cement.

In one embodiment, said polymer is selected from the group consisting of polyacrylic ester latex, dispersible latex powder, vinyl-acetate ethylene copolymer latex, SBR, polychloroprene rubber emulsion.

In one embodiment, said defoamer is mineral oil.

In one embodiment, said composition further comprises light weight aggregate, water-reducer, retarder, surfactant, water repellent agent, and thicker.

In one embodiment, the ratio of compressive strength to bending strength is less than 3 and the bending strength is 7 MPa or more.

In one embodiment, the ratio of compressive strength to bending strength is less than 2.6 and the bending strength is 9 MPa or more.

In one embodiment, the bonding strength between said spray polyurethane foam and said roof deck is above 0.2 MPa and water absorption rate of said composition is less than 2%.

### DETAILED DESCRIPTION OF THE PRESENT INVENTION

In the following detailed description, specific embodiments of the present invention are described in connection with preferred embodiments. However, to an extent that the following description is specific to a particular embodiment or a particular use of the present techniques, it is intended to be illustrative only and merely provides a concise description of the exemplary embodiments. Accordingly, the invention is not limited to the specific embodiments described below, but rather the invention includes all alternatives, modifications, and equivalents falling within the true scope of the appended claims.

As used herein:

Unless otherwise stated, all percentages (%) are by weight based on the total weight of the mortar composition. The descriptions of the various ingredients set forth below are non-limiting. Unless otherwise stated, all ranges defined here include endpoints.

The “mortar composition”, depending on different components, may be classified into “cement mortar” and “polymer modified mortar”. Cement mortar means a mortar composition comprising cement and fillers but having no emulsion polymer and other polymer-containing additives. Polymer modified mortar means a mortar composition comprising cement, fillers, emulsion polymer and/or other polymer-containing additives. The “mortar layer” is a layer made of the mortar composition and used in construction, such as exterior insulation finish system (EIFS) or roofing. In some cases, such a mortar layer is attached to a thermal insulation layer and used as a protective and mechanical abuse layer, as well as a substrate for adhesives, insulation, impact resistance, and fire resistance.

In one embodiment of the present invention, the mortar layer is made of a polymer modified composition comprising cement, aggregates, polymer, and defoamer. In one embodiment, the mortar composition further comprises other additives, such as synthesized fibers, dispersant, water-reducer, retarder, surfactant, water repellent agent, thickener, e.g. cellulose ether, etc.

The “polymer” used in the mortar composition of the present invention could be polymer powder or polymer emulsion.

“Polymer powder” is also named as “re-dispersible power (RDP)”, which is made by spray drying emulsion polymer in the presence of various additives such as a protective colloid, anti-caking agent, etc. Many types of polymers can be used to produce RDP including ethylene/vine ester copolymers (such as ethylene/vinylacetate copolymer), vinylacetate/vinyl-versatate copolymer, styrene/acrylic copolymer, etc. To carry out spray drying, the dispersion of the copolymer, if appropriate together with protective colloids, is sprayed and dried. When mixed with water, these polymer powders can be re-dispersed to form an emulsion, which in turn forms continuous films within cement mortar later when the water is removed by evaporation and hydration of cement.

Preferred vinyl esters for use in forming RDP copolymers include vinyl acetate, vinyl propionate, vinyl butyrate, vinyl 2-ethylhexanoate, vinyl laurate, 1-methylvinyl acetate, vinyl pivalate, and vinyl esters of alpha-branched monocarboxylic acids having from 5 to 11 carbon atoms. Some preferred examples include VEOVA™ 5®., VEOVA™ 9®, VEOVA™ 10®., VEOVA™ 11® (VEOVA is a trademark of Resolution Performance Products, L.L.C.) or DLP 2140 redispersible polymer powder (available from The Dow Chemical Company). Preferred methacrylic esters or acrylic esters include methyl acrylate, methyl methacrylate, ethyl acrylate, ethyl methacrylate, propyl acrylate, propyl methacrylate, n-butyl acrylate, n-butyl methacrylate, and 2-ethylhexyl acrylate. Preferred vinyl-aromatics include styrene, methylstyrene, and vinyltoluene. A preferred vinyl halide is vinyl chloride. The preferred olefins are ethylene and propylene, and the preferred dienes are 1,3-butadiene and isoprene.

The “polymer emulsion” or “polymer dispersion” means a two phase system having finely dispersed polymeric particles in solvent such as water. An aqueous emulsion polymer is normally composed of polymer particles, such as vinyl polymer or polyacrylic ester copolymer and a surfactant containing hydrophobic and hydrophilic moieties.

In one embodiment, the polymer of the mortar composition of the present invention is polyacrylic ester latex emulsion, dispersible latex powder, EVA (Vinyl-Acetate Ethylene Copolymer), styrene butadiene latex (SBR), or polychloroprene rubber emulsion (CR). In one embodiment, the polymer of the mortar composition of the present invention is polyacrylic ester latex emulsion, such as Tianba™ 2000 (Tianba is a trademark of The Dow Chemical Company).

“Glass transition temperature (Tg)” is the temperature at which the amorphous phase of a polymer is converted between glassy and rubbery states. Tg represents one of the most important mechanical properties for polymers. In the mortar composition of the present invention, Tg also plays an important role in selection of polymers. Higher Tg polymer means higher flexural and compressive strength the mortar layer can achieve, but the content of the polymer should also be high, which increases cost. Lower Tg polymer means softer of the mortar layer, which results in lower flexural strength. In one embodiment of the present invention, the Tg of the polymer is in a range of from about −15 to about 13° C. In one embodiment of the present invention, the Tg of the polymer is in a range of from −10 to about 8° C.

The content of polymer in the mortar composition is important to the performance of the mortar layer. Lower polymer fraction may result in the ratio of compressive strength to bending strength higher than the standard requirement which is 3 under GB50404-2007. In another aspect, the addition of polymer is limited due to cost consideration. In one embodiment of the present invention, the mortar composition of the present invention comprises about 2.5-11.0% polymer (dry weight) by weight of the total weight of the mortar composition. In one embodiment, the mortar composition comprises about 3-8% polymer (dry weight) by weight of the total weight of the mortar composition.

The thickness of the mortar layer may be various depending on performance requirement, such as waterproofing, compressive strength, etc. In one embodiment, the thickness of the mortar layer is in a range of from about 2.0 to about 10.0 millimeter (hereinafter “mm”). In one embodiment, the thickness of the mortar layer is from about 3 to about 5 mm.

“Cement” provides adhesive strength to substrate through hydration process in the presence of water. Sufficiently hydrated cement has very high mechanical strength as well as water resistance, but poor flexibility. Due to functional requirements in applications such as EIFS and roofing in the present invention, cement has to be modified by flexible polymers to serve as a suitable mortar layer for use in roofing. The previously described polymer powders or polymer emulsions are suitable flexible polymers for modifying cement to achieve a mortar composition for use in the roofing system of the present invention.

Portland cement is one type of cement suitable for use in the present invention. In one embodiment, the mortar composition comprises about 25-50% cement by dry weight of the total weight of the mortar composition. In one embodiment of the present invention, the mortar composition comprises about 28-40% cement (dry weight) by weight of the total weight of the mortar composition.

The ratio of polymer to cement should also be considered. A lower ratio could not achieve an acceptable ratio of compressive strength to bending strength. In one embodiment, the dry weight ratio of polymer to cement is about 0.12 or more.

“Aggregates” are widely used in conventional EIFS and roofing system and refer to inorganic material without binding function. They are used to 1) reduce cement content for less dry shrinkage and cost; 2) improve workability; 3) improve mechanical performances due to its densification; and 4) obtain enough paste content in mixture for wrapping light weight aggregates.

In an embodiment of the present invention, lightweight aggregates are used in the mortar composition. “Lightweight aggregates” are distinguished from other mineral aggregate materials by their lower densities. They typically have a density less than 1120 kg/m³. Use of lightweight aggregate allows builders to install a lighter concrete than those made with heavy aggregates. In addition to its weight savings, manufactured lightweight aggregate is valued because of its skid resistance, thermal insulating abilities, and strength. The “lightweight aggregates” are minerals, natural rock materials, rock-like products, and byproducts of manufacturing processes that are used as bulk fillers in lightweight structural concrete, concrete building blocks, precast structural units, road surfacing materials, plaster aggregates, and insulating fill. Lightweight aggregates are also used in architectural wall covers, suspended ceilings, soil conditioners, and other agricultural uses.

In an embodiment of the present invention, the aggregates used in the mortar composition are selected from quartz sand, perlite, vermiculite, fly ask, pumice, expanded clary, expanded polystryrene, beads, and carbon bead.

In one embodiment, the mortar composition comprises about 20-70% aggregates by weight of the total weight of the mortar composition. In one embodiment, the mortar composition comprises about 40-60% aggregates by weight of the total weight of the mortar composition.

The ratio of aggregates to cement also has an effect on the performance of the mortar composition. A higher ratio will result in lower bending strength. In one embodiment, the weight ratio of aggregates to cement is in a range of about 1.5-2.3.

“Dispersant” is used to help the dispersion of fillers (aggregates) and improve the workability of hydraulic binders. In an embodiment, the dispersant is a polymeric dispersing agent.

In an embodiment, the dispersant includes, for example, copolymers obtained by the radical copolymerisation of at least one alkoxy-, aryloxy-, alkylaryloxy-, arylalkyloxy- or alkoxy-polyalkylene glycol ethylenic urethane monomer, and more particularly, an alkoxy-, aryloxy-, alkylaryloxy- or arylalkyloxy-polyethylene glycol urethane, with at least one anionic monomer and at least one non-ionic monomer, optionally in the presence of an alkoxy-, aryloxy-, alkylaryloxy- or arylalkyloxy-polyalkylene glycol acrylate or methacrylate or an alkyloxy-, aryloxy-, alkylaryloxy- or arylalkyloxy-polyalkylene glycol allyl ether, and more particularly methoxy-polyethylene glycol acrylate or methacrylate.

In an embodiment of the present invention, the dispersant is anionic acrylic copolymer, such as GA 40 (a product of BASF).

In one embodiment, the mortar composition comprises about 0.05-0.4% dispersant by weight of the total weight of the mortar composition. In one embodiment, the mortar composition comprises about 0.1-0.2% dispersant by weight of the total weight of the mortar composition.

The ratio of dispersant to polymer posts an impact on the setting or the strength of cement in an extended period. In one embodiment, the ratio of dispersant to polymer is 0.03 or less. In one embodiment, the ratio of dispersant to polymer is 0.01-0.03.

The “defoamer” (or “defoaming agent”) is used in the mortar composition to remove air voids that form when cement and aggregates are mixed with an aqueous polymer solution. Therefore, the defoamer will affect the performance after setting of cement-based mortar, such as compressive strength and bending strength.

In an embodiment of the present invention, suitable defoamers include, but are not limited to silicone-based defoamers (such as dimethylpolysiloxane, diemthylsilicone oil, silicone paste, silicone emulsions, organic group-modified polysiloxanes (polyorganosiloxanes such as dimethylpolysiloxane), fluorosilicone oils, etc.), alkyl phosphates (such as tributyl phosphate, sodium octylphosphate, etc.), mineral oil-based defoamers (such as kerosene, liquid paraffin, etc.), fat- or oil-based defoamers (such as animal or vegetable oils, sesame oil, castor oil, alkylene oxide adducts derived therefrom, etc.), fatty acid-based defoamers (such as oleic acid, stearic acid, and alkylene oxide adducts derived therefrom, etc.), fatty acid ester-based defoamers (such as glycerol monoricinolate, alkenylsuccinic acid derivatives, sorbitol monolaurate, sorbitol trioleate, natural waxes, etc.), oxyalkylene type defoamers, alcohol-based defoamers: octyl alcohol, hexadecyl alcohol, acetylene alcohols, glycols, etc.), amide-based defoamers (such as acrylate polyamines, etc.), metal salt-based defoamers (such as aluminum stearate, calcium oleate, etc.) and combinations of the above-described defoamers.

In an embodiment of the present invention, suitable defoamer is mineral oil, such as Foamster™ NXZ (Foamster is a trademark of Cognis Corporation).

In one embodiment, the mortar composition comprises about 0.01-1% defoamer by weight of the total weight of the mortar composition. In one embodiment, the mortar composition comprises about 0.05-0.2% defoamer by weight of the total weight of the mortar composition.

The ratio of defoamer to polymer is also important to the performance of the mortar composition. A lower ratio will leave too much foam in a mortar mixture, which will reduce the strength of cement after setting. On the other hand, a higher ratio of defoamer to polymer will make the mortar mixture denser and therefore significantly increases the compressive strength. In one embodiment, the dry weight ratio of defoamer to polymer is in a range of about 0.005-0.03. In one embodiment, the dry weight ratio of defoamer to polymer is in a range of about 0.008-0.015.

“Synthesized fibers”, also named as “polymer fibers”, are used to reinforce or otherwise improve the properties of concrete by applying them to aqueous based concrete mixes prior to the curing of the concrete. Suitable types of synthesized fibers in include those composed of polyolefins, especially polypropylene, polyester, polyamide, polyacrylic and polyvinyl alcohol.

Polypropylene fibers are produced by a well known melt spinning process, in which molten polymer is pumped through a die having a large number of small openings to produce continuous filaments. The use of polypropylene fibers is desirable for several reasons, including low raw material cost, excellent physical properties, and the nonreactive properties of the polymer in the alkaline concrete mix.

In one embodiment, the mortar composition comprises 0.01-1% polymer fiber by weight of the total weight of the mortar composition. In one embodiment, the mortar composition comprises 0.1-0.4% polymer fiber by weight of the total weight of the mortar composition.

The “viscosity modification agent” or “thickener” is used in construction industry to modify the viscosity of the mortar composition and to retain water. Examples of thickeners are any one or combination of more than one of: polysaccharides such as cellulose ethers and modified cellulose ethers, starch ethers, guar gum, xanthan gum, phyllosilicates, polycarboxylic acids such as polyacrylic acid and the partial esters thereof, optionally acetalized and/or hydrophobically modified polyvinyl alcohols, casein, and associative thickeners. In one embodiment, the thickener is cellulose ethers, modified cellulose ethers, optionally acetalized and/or hydrophobically modified polyvinyl alcohols, and mixtures thereof.

Too much thickener will introduce foams and slow the setting, which will decrease the strength of the mortar composition. In another aspect, lower content of thickener can not achieve the effect of water retention. In one embodiment of the present invention, the thickeners fraction is from 0.01% to 1% by weight based on the total weight of the mortar composition. In another embodiment, the thickeners fraction is from about 0.03% to about 0.7% by weight based on the total weight of the mortar composition. In another embodiment, the thickeners fraction is from about 0.05% to about 0.2% by weight based on the total weight of the mortar composition.

In one embodiment of the present invention, the mortar composition further comprises other additives, such as water-reducer, retarder, surfactant, water repellent agent, etc.

The “thermal insulation foam” means thermal insulation materials used in construction industry. In some embodiments, the thermal insulation materials can be foam boards (such as EPS or XPS), polyurethane foam (such as SPU), or phenolic foam, all of which can provide thermal insulation to the building as well as meet insulation/energy codes. A mortar layer is normally adjacent to the thermal insulation foam board and in one embodiment, a primer layer may be present between the thermal insulation foam and the mortar layer.

“Extruded polystyrene layer” or “extruded polystyrene (XPS) foam board” refers to a foam board prepared by expelling an expandable styrenic polymer foam composition comprising a polymer and a blowing agent from a die and allowing the composition to expand into a polymeric foam. Typically, extrusion occurs from an environment of a pressure sufficiently high so as to preclude foaming to an environment of sufficiently low pressure to allow for foaming. Generally, extruded foam is a continuous, seamless structure of interconnected cells resulting from a single foamable composition expanding into a single extruded foam structure. However, one embodiment of extruded foam includes “strand foam”. Strand foam comprises multiple extruded strands of foam defined by continuous polymer skins with the skins of adjoining foams adhered to one another. Polymer skins in strand foams extend only in the extrusion direction of the strand.

“Expanded polystyrene layer” or “expanded polystyrene (EPS) foam board” refers to a foamed board comprising multiple foamed styrenic polymer beads adhered to one another prepared in an expandable polymer bead process by incorporating a blowing agent into granules of polymer composition (for example, imbibing granules of polymer composition with a blowing agent under pressure). Subsequently, expand the granules in a mold to obtain a foam composition comprising a multitude of expanded foam beads (granules) that adhere to one another to form a “bead foam.” Pre-expansion of independent beads is also possible followed by a secondary expansion within a mold. As yet another alternative, expand the beads apart from a mold and then fuse them together thermally or with an adhesive within a mold.

### EXAMPLES

Test 1

1. Preparation Process

A mortar composition is prepared following the steps as below.

Component 1 (powder) and Component 2 (liquid) are formulated separately according to Table 1. Both are separately blended to a homogeneous condition by using the mixer specified in China code JC/T 681*. Component 2 is first added into a mixing bowel, followed by adding Components 1. The mixing lasts about 60 seconds at a low velocity and then stops for 5 minutes. During the 5 minutes, the blades of the mixer are cleaned and unmixed dry components are scraped from the inner surface of the mixing bowel into the mixture. Continue the mixing for another two minutes to obtain the mortar composition. *JC/T 681-2005, “Planetary cement mortar mixer” stipulated by National Development and Reform Commission.

2. Components

TABLE 1
Raw material and the Example formulation (waterproofing protective mortar)

| | Chemical | | | | Parts by |
|---|---|---|---|---|---|
| Component | name | Grade name | Function | Supplier | weight |
| Component 1 | | | | | |
| powder | | | | | |
| Cement | Portland | 52.5 | Binder | Xiao Ye Tian Cement | 30.62 |
| | cement | | | Co., Ltd. | |
| Aggregate | Quartz sand | 40-70 mesh, 0.25- | Filler | Linking Complex | 21.44 |
| | | 0.45 mm | | (Suzhou) co. ltd | |
| Aggregate | Quartz sand | 70-140 mesh, 0.12- | Filler | Linking Complex | 21.44 |
| | | 0.25 mm | | (Suzhou) co. ltd | |
| Aggregate | Quartz sand | 250 mesh, | Filler | Linking Complex | 7.1 |
| | | 0.063 mm | | (Suzhou) co. ltd | |
| Cellulose | Methyl | Methocel (MW | Water | Dow Chemical | 0.1 |
| ether | Hydroxyethyl | 15000PFV) | Retaining | | |
| | Cellulose | | | | |
| Polypropylene | Polypropylene | 6 mm | Anti-crack | Zhangjiagang Fangda | 0.1 |
| fiber | fiber | | | Special Fibre | |
| | | | | Manufacturing co. ltd | |
| Component 2 | | | | | |
| liquid | | | | | |
| Latex | Polyacrylic | Tianba 2000 | Binder | Dow chemical | 9 |
| | ester latex | | | Company | |
| Deformer | mineral oil | Foamster NXZ | Deformer | The Cognis Corporation | 0.05 |
| Dispersant | Anionic | GA40 | Dispersant | BASF Company | 0.15 |
| | Acrylic | | | | |
| | copolymer | | | | |
| Water | | | | | 10 |

Note:
total weight of the mortar composition (component 1 and 2) are 100 by weight.

3. Test Method and Results

The tested method and properties of the mortar are listed in Table 2.

TABLE 2

| | | | | Code |
|---|---|---|---|---|
| | | Test | Test method | Requirements |
| Properties | Unit | result | refer to | (GB50404^{d}) |
| Bonding strength with | MPa | 1.02 | JC/T 984-2005^{a} | >1.0 |
| concrete substrate | | | | |
| Bending strength | MPa | 10.255 | JC/T 984-2005 | >7 |
| Compressive strength | MPa | 21.95 | JC/T 984-2005 | |
| Compressive/Bending | | 2.14 | JC/T 984-2005 | <3 |
| strength | | | | |
| Water absorption % | | 1.23 | JC 474-2008^{b} | <6 |
| Bonding strength with | MPa | 0.25 | JG 149-2003^{c} | |
| SPU | | | | |

^{a}Construction Material Standard on “Polymer modified cement mortar for waterproof” stipulated by National Development and Reform Commission.
^{b}Construction Material Standard on “Water-repellent admixture for mortar and concrete” stipulated by National Development and Reform Commission.
^{c}Construction Material Standard on “External thermal insulation composite system based on expanded polystyrene” stipulated by Ministry of Housing and Urban-rural Development of China.
^{d}GB50404-2007, “Technical code for rigid polyurethane foam insulation and waterproof engineering” stipulated by general administration of quality supervision, inspection and quarantine of the people's republic of China″.

It is normally understood that the ratio of compressive to bending strength less than 2.6 while keeping bending strength above 9 MPa (minimum required value is 7 MPa) is very hard to achieve based on the formulations in current market. Said ratio in the composition of the present invention is as low as 2.14 while keeping the bending strength more than 10MPa.

In addition, the mortar composition disclosed in Table 1 here also has good bonding strength to SPU substrate and less water absorption than most products in the current market, which highly exceeds the code requirements. A good bonding strength to SPU substrate means it is compatible with the insulation substrate, which is critical in the SPU insulation and waterproofing integrated system.

Test 2

A comparison trial is conducted to show the effect of cement content on the mortar composition. A mortar composition is formulated as Table 3.

TABLE 3

| Components | Parts by weight | % by weight |
|---|---|---|
| 52.5 Portland cement | 21 | 21 |
| Quartz sand 40-70 mesh | 31.25 | 62.5 |
| Quartz sand 70-140 mesh | 31.25 | |
| Polypropylene fiber | 0.1 | 0.1 |
| METHOCEL ™(MW | 0.1 | 0.1 |
| 15000PFV) | | |
| TIAKBA ™ 2000 | 10 | 10 |
| Foamster ™ NXZ | 0.05 | 0.05 |
| GA 40 | 0.15 | 0.15 |
| water | 6.1 | 6.1 |
| Sum | 100 | 100 |

Test Results

| | |
|---|---|
| cement | 21% |
| sand/cement | 2.98 |
| Latex(solid)/cement | 0.27 |
| Defoamer/latex (solid) | 0.0088 |
| bending strength | 2.89 |
| compressive strength | 8.40 |
| compressive strength/bending strength | 2.91 |

METHOCEL and TIAKBA are trademarks of The Dow Chemical Company Foamster is a trademark of Cognis Corporation.

The composition in Table 3 comprises 21% cement, which is much lower than that in Table 1 and results in different sand/cement and latex/cement ratios.

The test result illustrates that lower cement results in lower bending strength while keeping the ratio of bending strength/compressive strength lower than 3, although the latex/cement ratio is larger than 0.12.

1. A roofing system comprising a thermal insulation foam layer, which is applied onto a roof deck, and a mortar layer, wherein said thermal insulation foam layer is between said roof deck and said mortar layer and said mortar layer is made of a mortar composition comprising:
(a) about 28-40% cement;
(b) about 40-60% aggregate;
(c) about 0.05-0.2% defoamer; and
(d) about 3-8% polymer by weight of the total weight of said mortar composition and wherein the weight ratio of polymer to cement is about 0.12 or more.

2. The roofing system according to the claim 1, wherein the weight ratio of defoamer to polymer is about 0.005-0.03.

3. The roofing system according to the claim 1, wherein the weight ratio of defoamer to polymer is about 0.008-0.015.

4. The roofing system according to the claim 1, wherein the aggregate/cement weight ratio of said mortar composition is from about 1.5 to about 2.3.

5. The roofing system according to the claim 1, wherein the Tg of said polymer is in a range from about −10 to about 8° C.

6. The roofing system according to the claim 1, wherein said thermal insulation foam layer is spray polyurethane foam.

7. The roofing system according to the claim 1, wherein said composition further comprises a dispersant of about 0.1-0.2% by weight of the total weight of said composition.

8. The roofing system according to the claim 7, wherein the weight ratio of said dispersant to said polymer is about 3% or less by weight of the total weight of said composition.

9. The roofing system according to the claim 7, wherein said dispersant is anionic acrylic copolymer.

10. The roofing system according to the claim 1, wherein said polymer is selected from the group consisting of polyacrylic ester latex, vinyl-acetate ethylene copolymer latex, dispersible latex powder, SBR, polychloroprene rubber emulsion.

11. The roofing system according to the claim 1, wherein the thickness of said mortar layer is from about 3 to about 5 mm.

12. The roofing system according to the claim 1, wherein the ratio of compressive strength to bending strength is less than 3 and the bending strength is 7 MPa or more.

13. The roofing system according to the claim 1, wherein the ratio of compressive strength to bending strength is less than 2.6 and the bending strength is 9 MPa or more.

14. The roofing system according to the claim 1, wherein the bonding strength between said spray polyurethane foam and said roof deck is above 0.2 MPa and water absorption rate of said composition is less than 2%.
